(19) United States
(12) Patent Application Publication
(10) Pub. No.: US 2010/0051212 A1
(43) Pub. Date: Mar. 4, 2010

(54) Vertical blind, an optical quality shatter and impact resistant, two-sided mirrored acrylic vane

(76) Inventor: Debbie I. R. Novak, Edmonton (CA)

Correspondence Address: Debbie I. R. Novak, 11034 -123 street, Edmonton, QC, T5M 0E3, CA

(21) Appl. No.: 12/587,095

(22) Filed: Oct. 2, 2009

(30) Foreign Application Priority Data
Jun. 11, 2008 (CA) 2634471

(51) Int. Cl. E06B 9/36

(52) U.S. Cl. 160/178.1 V

(57) ABSTRACT

The invention is a window covering wherein individual shatter and impact resistant optical quality two sided mirrored acrylic vanes are suspended vertically and have a plurality of elongate substantially planar vanes having opposite longitudinal side edges. The two-sided optical quality shatter and impact resistant rigid mirrored acrylic material become the front and rear sides respectively of each vane.

### FIELD OF THE INVENTION

This invention is in the field of window coverings. The invention is a vertical blind wherein the individual vanes have: unique shatter and impact resistant, optical quality, two-sided mirrored, acrylic vanes. The front side and the rear sides, dual mirrored surfaces form an optical quality vane of rigid but relatively flexible, optical grade mirrored acrylic.

### BACKGROUND OF THE INVENTION

Mirrors have been traditionally made of glass, therefore the use of the same would be unsuitable due to their weight and tendency to shatter in particular where the application is a window covering. These optical quality, shatter and impact resistant, two-sided mirrored, vertical blind vanes differ from the traditionally-oriented in that each vanes extension reflects in optical quality, the surrounding atmosphere (dual surface) and reflects light and mirrors image in both front and rear specifications.

In a typical vertical blind, the individual vanes are normally a solid color, comprising of, a strip of patterned cloth or other material. These individual vanes transmitted light in a diffused manner or were formed from an opaque material usually bowed to increase its stiffness.

As vertical blinds are very versatile, some problems in their design have become apparent. Firstly, the blinds that have thin translucent vanes do not sufficiently diffuse or block the light transmitted at night allowing objects or people within the room diminished privacy.

A second problem associated with the translucent, thin, vane is that the flexibility inherent in the vanes allows for an excessive degree of movement. For example, even slight air currents can cause the vanes to swing outwardly.

A third problem with the thin vanes is that they are not aesthetically substantial in appearance and thus detracts from their overall appearance.

Problems with other vertical blinds also give subject to the desire to have the front surface of each vane a different color from that of the rear surface. This is extremely difficult to achieve with the thin vanes since the translucent material of the vane allows the same color or pattern to be visible from the opposite side. Wherein the exterior view of the vertical blind may differ with color from an interior view point. Therefore limiting corresponding color within the interior and the exterior of their application.

Furthermore, painting vertical blind vanes or the addition of a mechanism for the attachment of colored, mirrored elements or other decorative features increases the cost substantially and may detract from the appearance and styles of function.

In U.S. Pat. No. 6,119,759 the addition of mirrored elements (reflective material) is described as being attached to the faces of the slats and forming, one part of a three part trapezoidal slat or louver for use in a shutter system that has a horizontal, roll-up type of motorized pivoting system, a device for opening and closing a building space. The invention described, is limited to mirrored elements on the face of the slat. One side being reflective or deflective (reflecting or deflecting the suns rays (exterior) or reflecting the light (interior), failing to encompass the use and functionality of two-sides (front and rear surface) useful in reflecting and deflecting light or the suns' rays, in both directions either interior or exterior, simultaneously. The reflective material described (mirrored elements), in prior art is vague, as to the optical quality of the attached mirrored elements. The new invention for a vertical-type two-sided mirrored acrylic blind vane wherein the front surface and the rear surface form one part when bonded, a dual, optical quality mirrored front and optical quality mirrored rear surface unique in appearance and further utilizes the dual mirrored surfaces ornamental improvement, with the unexpected visual results and uses created in the identically mirroring, duplicating, reflecting, deflecting and encompassing the surrounded space of the two mirrored surfaces (front and rear) of the vanes, simultaneously. The front surface reflects or deflects light (interior view) and the rear surface directs light and the suns' rays (exterior view) in a simultaneous and useful manner, when opened, semi-opened or closed. The vanes are substantially rigid and have no attachments of mirrored elements. The vanes construction is one part mirrored acrylic when assembled, a duplicity, formed using two sheets of optical quality mirrored acrylic that is shatter and impact resistant, an additional benefit utilized using acrylic. The vanes differ in opening and closing, left to right, in the middle (such as draperies) not up or down as in the roll-up type slat, horizontal blind referred to in this prior art. The dual mirrored surface vertical blind vanes (the invention) completely differs in the function and appearance and technical effects to that of a horizontal blind. The horizontal type roller blind or shutter system comprise slats or louvers (not vanes) they are diminished in width of slat, roll-up, have a different shape, width, size, and appearance when in an opened, closed or diffused manner (semi-opened), have attachments of mirrored elements on one-side and are pivoted horizontally (semi-opened), the face of the slats comprising attached mirrored elements (one sided), with no mention of the reflective or optical quality of the mirrored element type material that is utilized. The motorized system of opening and closing the slats have many moveable parts that are mechanically operated adding an electrical cost with a probable need for maintenance.

In concluding prior art, Japan Patent No: 3182323, manufacture of a sun visor for a motor car, by a method wherein the thin layer of soft resin material is bonded to a fabric and resin for a mirror is bonded onto the thin layer of the soft resin material through ultrasonic welding to form a mirror while the fabric, having an area slightly smaller than the resin for the mirror, is removed before or after forming the mirror. There are different types of acrylic resins and resin compounds and methods for forming acrylic resins, such as cell-cast sheet, continuous cast, extruded or injected molded. Acrylics are utilized in a wide variety of uses such as dentures, skylights, air craft cabins, camper tops, varnishes, paints, adhesives, etc. Also, different substrates utilized and finishes for mirrored surfaces, such as, glass, mylar (silver paper material) plastic, etc. Not all acrylics or acrylic resins are created equal when it comes to an optical quality, durability, reflectiveness and mirroring process. The clarity of the mirrored surface and the specific application is very important when determining what is right for the many different applications that are utilized using acrylic. Different compounds types and methods for achieving quality are a definite factor. Reflection and mirroring may be distorted and may be unclear and or flawed (not optically utilizing the best method, thickness and compounds). Mirrors are generally thought of as having one-side, (front facing surface with an opaque back)

Traditionally, mirrors are one sided with the mirrored surface facing front, and the rear surface (opaque) attached to a wall, slat, louver, door or in this invention a sun visor for a motor car. A two-sided mirror, lends itself to a completely different use and function when applied to a vertical blind vane for a (window covering). The improvement being, a two-sided mirror (dual surface) mirroring and duplicating, reflecting and deflecting, in alternating directions, that is specular and unexpected in the appearance(s) from different view points and technical aspects of the optically mirrored surfaces. An opaque backing and laminated on to a material such as in the sun visor (one-side), would have no purpose or usefulness when used or applied in a window covering application, whereat both sides are to be exposed in either direction, front facing or rear facing. The appearance and the function of reflecting and deflecting in duplicity is accomplished and solved with a two-sided, (dual surface) application for mirroring, reflecting and deflecting, simultaneously. It is extremely important to note that the acrylic resin used in this example of prior art, is in the raw form, until being processed for the specific application. Examples of acrylic resins used are conventionally known, various acrylic resins, namely, polymer of acrylic acid and methacrylic acid and polymers of acrylate and methacrylates. The method and compounds used to form a mirror vary in comparison, from optical quality and other factors such as strength, shatter-resistance, thickness, rigidity, design or shape, and the application thereof. In prior art a sun visor for a motor car, differs in the method used in forming mirrored acrylic sheet, for the (two-sided vane(s), shatter and impact resistance, and the optical quality, that is necessary for the use and function in a vertical blind (vane(s) that cover a window. Mirrored sheet is molded while both surfaces or metal belt surfaces thereof are in contact with metal roll surfaces. The one-sided mirrored application and method thereof, is useful for a sun visor comprising (acrylic resin elements) forming a mirror.

The method, use and application are substantially different than the use for a rigid, optical quality mirrored acrylic, forming the vane(s) two-sided mirrored acrylic sheet, formed and fashioned, (front surface and rear surface) into one part (the vane), being two-sided (dual surface) impact and shatter resistant, used in a interior or exterior application and encompasses an interior or exterior view point, simultaneously. The new use, application, innovative improvement and unexpected results created by the two-sided dual mirrored surfaces. The two-sided dual mirrored acrylic surfaces vanes, define a new mode of design and functionality for a very unique window covering.

### SUMMARY OF THE INVENTION

The present invention provides an optical quality, two-sided (dual surface) (two bonded sheets) shatter and impact resistant, mirrored acrylic vane(s). In that they are light and exact image, reflective on both sides as in the quality found in glass mirror and attain a specular reflecting dual surface (front and rear surface) therein.

The vanes are extended from a standard type of headrail and can be rotated in place or caused to slide to one end of the headrail (right or left side) or split stack (middle opening) by a pulley system. It should be noted that a variation of width or length can be made to the basic design of the vertically mirrored dual surface vane(s) without departing from the basic concept of the invention.

Individual vanes are, two-sided, (two bonded sheets), optical grade, shatter and impact resistant, mirrored acrylic, with a vacuum metallized aluminum providing the superior dual reflecting, mirrored surfaces. The planar vanes having opposite longitudinal side edges and are suspended vertically. The two-sided (two bonded sheets) of optical quality, mirrored acrylic sheet become the front and the rear sides respectively of each vane. The reflectivity is approximately 85-90% over the 400-700 nanometer visual light spectrum, shatterproof and demonstrate the highest level of scratch resistance silicone hard coating. Acrylic is well known for attaining the best possible mirrored substrate in the market place today. Less than one half the weight of glass in the same size and thickness. The rigid 0.120 mm thickness of the vane(s) have a tested coefficient of thermal expansion, −30 to 30 C, that function in the interior or the exterior environment which include exposure to the sunlight.

The plurality of the elongated vanes as defined by the planar front and rear mirrored surfaces, create a unique dimensional and technical effect, wherein, light and image are mirrored and duplicated with unexpected results. Unlike the prior type vanes, slats or louvers, whereat, the visual effect is that of only one side, no mention of optical quality and reflection of the said attached mirrored elements, an opaque non-ornamental surface. The innovative improvement, functionality and application (vertical blind vane(s) two-sided mirrored acrylic vane(s) front and rear surfaces when in a closed or semi-opened application directs light and reflects light. The exterior space (outside landscape) and the interior space (inside design) reflect, mirror and duplicate, simultaneously. The two-sided optical grade, mirrored acrylic blind vane allows no light to be transmitted through the vane therefore increasing the total privacy. In addition adds an unexpected technical result by mirroring and duplicating the surrounded area due to the reflected and deflected light thereof.

The invention's method of construction provides a number of other distinct advantages. The two-sided, optical grade, shatterproof and impact resistant, mirrored acrylic is comprised of a lightweight acrylic, (two sheets bonded) that fashion the two sides (dual surface) of the optical grade, mirrored acrylic vanes.

Both rear surfaces have an opaque film of aluminum, protected by a gray paint backing that is the most durable, toughest scratch-resistant backing in the mirror industry. The dual surface reflection property is ideal for those applications where the rear surface (back side) of the mirror will remain expose, or where a reflection in both directions is desired such as a window covering being a vertical blind with vane(s). The vane(s) when assembled are durable and uniform (one part), being two-sided (dual surface) mirrored acrylic, light incident from either direction reflected, and specular in appearance, functionality and a much needed improvement and enhancement of prior art.

To assemble the vane the first sheet of (0.60 mm) thickness, mirrored acrylic has an equal width of (48 inches) and equal length of (96 inches) to the second sheet (0.60 mm) thickness (48 inches by 96 inches) During assembly the first sheet and the second sheet (rear surfaces) are bonded permanently, (rear surface to rear surface) The acrylic mastic adhesive uniformly coats the rear surfaces of the mirrored acrylic sheet. The union, cohesion and alignment of the two sheets rear surfaces is achieved in a uniform and exact manner by carefully pressing the sheets in place (back to back). This is furthering the fully integrated manufacturing process which converts acrylic monomer into acrylic polymer and then into acrylic sheet which is state of the art and therefore will not be discussed any further. The two sheets bonded are crystal clear, glossy, durable, optical quality mirrored (dual surface) joined securely rear surface to rear surface sheets that are weather resistant, shatter and impact resistant due to the bonding process of the two sheets rear surfaces. Thus forming an optical quality, two-sided mirrored acrylic sheet (front and rear surfaces) (0.120 mm) thickness, (48) inch width and (96) inch length. The two-sided mirrored acrylic sheet is machine cut to the vanes(s) dimensional width of (3.5) inches, not exceeding (96) inches in length. Thus forming the flawless vane(s) two-side mirrored optical quality shatter and impact resistant reflective and mirroring surfaces. This inventive process and method of combining the two sheets back to back solve the problems associated with the incidence of pin hole light transmission (flawed). This unique method of combining the two sheets rear surfaces, constructing the vane(s) enables the light to be reflected and the surrounding space duplicated when in a semi-opened or closed position mirrored with a unique two-sided mirrored optical quality that is not transparent to light. The common substrate used for the purpose of mirror is sheet glass which has extremely good optical quality on one-side, the same as, but not equal to this two-sided mirrored, shatter and impact resistant acrylic (vane(s), application. The production and marketing of such sheet glass mirrors normally involves substantial costs due to the breakage during the transportation and marketing of the finished product. The two-sided mirrored acrylic vanes can be jarred or jolted with no breakage and will withstand severe shock and impacts without fracture, thus enabling a much lower cost in marketing, transportation, and the aesthetically unique properties (two-sided) dual mirrored surfaces, mentioned herein.

The planar front and rear mirrored surfaces, provide the vanes with a capacity for enhancing the reflective performance from the exterior side of the vane(s) as well as from the interior. The capacity for reflecting and transmitting light is a definite beneficial feature when necessary to direct light within a space. The reflection of the subsequent light present in the space becomes doubled (dual surface) by the deflecting, transmitting, and reflection of the light present, in both directions by the two-sided optical quality mirrored vane(s).

In addition, the thickness of the vane (s) maintains a superb optical integrity as it is rigid and less flexible than prior art attachments and eliminates visual distortion. The transparent, smooth finished edge is obtained by a stationary polishing head, the two-sided mirrored acrylic vane(s) edges become seamless and uniform, visually. The optical grade mirrored quality of the vanes, outstanding and unexpected results, unify, with the window glass creating a unique dimensional surrounding space. This invention for a window covering, being two-sided optical quality mirrored acrylic, shatter and impact-resistant vertical blind (vane(s) duplicates, reflects, mirrors and enhances the (interior or exterior decoration design) to all creative applications imaginable. The effect is that of a chameleon. As does a chameleon, (small lizard) change colors to mimic their environment, the optical grade, two-sided mirrored acrylic vertical blind vane(s), (the invention) change colors in exacting, mirroring, replicating and duplicating the environment within, thus enhancing the surrounded created space of each intellectuals', artistic ability.

### BRIEF DESCRIPTION OF THE DRAWINGS

FIG. 1 is a front view of a vertical blind (window covering) in accordance with the invention, two-sided, optical quality, shatter and impact resistant, mirrored, acrylic vanes, thereof, in a fully closed condition.

FIG. 2 is a front view of a two-sided, optical quality, mirrored vane, with arrows perpendicular to each side demonstrating the mirrored surface, and the subsequent reflection and mirroring aspects, obtained from the front surface and the rear surface. (two-sided)

FIG. 3 is the front view of a vertical blind (window covering) shown in FIG. 1 with the two-sided, optical quality, shatter and impact resistant, mirrored, vanes, thereof, in a semi-open condition.

FIG. 4 is the front view of a vertical blind (window covering) shown in FIG. 1, two-sided, optical quality, shatter and impact resistant, mirrored, vanes, thereof, in a fully opened position.

FIG. 5 is a slot, located at the top end of each individual, optical grade, two-sided mirrored acrylic vane, attaching the said vanes, via the headrails, clip or attaching mechanism. The vane (two sheets bonded) together.

FIG. 6 is line art that demonstrates the optical grade quality of the mirrored acrylic vanes surface area in a closed position that duplicate and replicate the surrounding environment.

### DETAILED DESCRIPTION OF THE DRAWINGS

Referring to the drawings in greater detail, wherein, like reference characters refer to like parts throughout the several figures, there is shown by the numeral 1 a vertical blind in accordance with the invention.

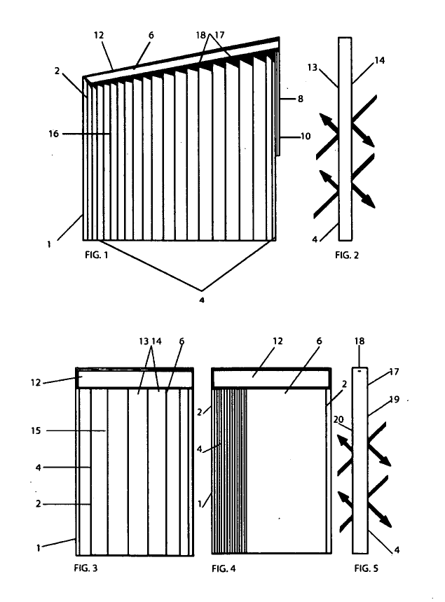

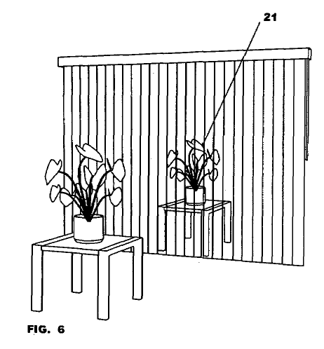

FIG. 1 shows the blind in a fully closed position in front of a window opening 2 (shown in phantom in FIG. 1). The blind consists of a plurality of individual, optical quality, two-sided, mirrored, shatter and impact resistant, vanes 4, that are extending downward, from a top-located headrail 6 (shown in phantom in FIGS. 3, and 4), that is the type normally used for vertical blinds. Adjusters 8 and 10 (shown in FIG. 1 only) are located at the extreme left or right side of the headrail to enable a user to rotate the vanes or to cause the vanes to slide across the window opening. A fixed cover or valance 12 is used to conceal the headrail assembly.

FIGS. 2 and 3 shows two sides, 13 and 14 where an optical grade mirrored reflection is obtained within each individual side of the vane 4. FIG. 2 provides a perspective view of one of the vanes 4. Each vane is fashioned from a rear sheet 13 and a front sheet 14 of optical grade, two-sided, mirrored acrylic vane 4 that is totally reflective and mirrors light and surrounding space. In this manner, any light that impinges on the front or rear surface 13 and 14 is reflected by the vanes 4, and mirrored in the process.

FIG. 3 shows the blind in a semi-open position in which the vanes have been rotated 90 degrees from the orientation shown in FIG. 1. In this position, light can pass directly through the plurality of blinds, via spaces 15 between adjacent vanes 4. FIG. 1 exhibits, subsequent individual vanes 4, a plurality of elongated, longitudinally-aligned, smooth polished, optical grade mirrored acrylic, 16, adjacent to each other in a closed position FIG. 1.

FIG. 4 exhibits the vertical blind in a fully open condition. The vanes have all been moved to the extreme left of the headrail and are oriented in front-to-back contact.

FIG. 5 is the slot, 17 located at the top end of the window opening (shown in phantom) FIG. 1. The clip or headrail attachment 18, located and connected to the headrail assembly, attach to each individual, optical grade, two-sided mirrored acrylic, vanes 4, slot 17, which rotates the said vanes 4, in closed position, FIG. 1 or semi-opened position, FIG. 3 or open position FIG. 4. The vane 4 (two-sides bonded) 19 and 20. It should be noted that alternate well-known attachment methods may be employed such as mechanical fasteners 18.

FIG. 6 is line art of the vertical blinds, optical quality, mirrored, vanes 4 in a closed position FIG. 1, which demonstrates the unique optical quality of the reflected and mirrored surrounded space that replicate in a duplicity the encompassed environment.

It should be noted that a number of variations can be made to the basic design of the vanes without departing from the basic concepts of the invention. For example, size or height, texture, thickness or shape of the vanes are similarly variable and the width may be changed. The vane 4 in FIGS. 5, 19 and 20 exhibit the two sheets of mirrored acrylic (rear surfaces) bonded and fashioned into a single sheet or vane 4, therein, creating the two-sided, planar front and rear mirrored surfaces.

Another alternate embodiment of the two-sided, optical quality, shatter resistant, mirrored acrylic vane 4, is the use of color, in the same application as described above. Therefore not departing from the scope of the invention.

The embodiments disclosed herein have been discussed for the purpose of enlightenment and familiarizing the reader with the novel aspects, use, and process for the fashioning of the dual mirrored surface, optical quality, shatter and impact-resistant, two-sided mirrored acrylic vane(s) for use in a vertical-type blind mechanism. Although the preferred embodiment of the invention has been shown and described, changes, modifications or substitutes may be made by one having ordinary skill in the art without departing from the scope of the invention which is defined by the following claims:

The embodiments of the invention in which an exclusive property or privilege is claimed are defined as follows:

1. A dual mirrored surface optical quality, shatter and impact resistant, two-sides mirrored acrylic blind vanes, capable for use in a vertical-type blind vanes window covering system comprising, in combination:
a bonded rear surface to rear surface mirrored acrylic sheet; and a vertical-type blind vane head rail mechanism; and a plurality of elongated dual mirrored surface acrylic blind vanes vertically-oriented; and
a vertical-type blind vane head rail mechanism for operating the said vanes; and a vertical-type blind vane head rail mechanism for supporting the said vanes at predetermined top end points; and a optical quality rigid in thickness two-sided mirrored acrylic vane; and
a shatter and impact resistant two-sided mirrored acrylic vane; and a planar front optical quality mirrored acrylic surface vane;
a planar rear optical quality mirrored acrylic surface vane; and a top end, a bottom end, a slot, a opposite longitudinal side edge and a longitudinal axis extending between said top and bottom ends.

2. The vertical-type two-sided mirrored acrylic blind vane window covering system of claim 1 wherein the optical quality planar front and planar rear mirrored acrylic surfaces are used in a functionality for reflection, deflection, duplication, and replication of the encompassed environment as the optical clarity and quality recognized in a glass mirror.

3. The vertical-type two-sided mirrored acrylic blind vanes window covering system of claim 1 wherein the vertical-type blind head rail mechanism asserts the access of operation for rotation, opening, closing, semi-opening, diffusing and directing of the said plurality of elongated mirrored acrylic blind vanes.

4. The vertical-type two-sided mirrored acrylic blind vanes window covering system of claim 1 wherein the vertically-oriented dual mirrored surfaces of individual two-sided mirrored acrylic vanes, attach to and extend downwardly from the vertical-type blind vane head rail mechanism.

5. The vertical-type two-sided mirrored acrylic blind vanes window covering system of claim 1 wherein a slot is machine cut at center point equally distant from the sides edge of the said vanes.

6. The vertical-type two-sided mirrored acrylic blind vanes window covering system of claim 1 wherein the slot center point equally distant from the sides edge at the top end of the vertical blind vanes allows for attachment to the vertical-type blinds vanes head rail mechanism.

7. The vertical-type two-sided mirrored acrylic blind vanes window covering system of claim 1 wherein the front mirrored and rear mirrored planar surfaces of the vanes extend from the top and to the bottom end of the associated vanes.

8. The vertical-type two-sided mirrored acrylic blind vanes window covering system of claim 1 wherein the front mirrored and the rear mirrored planar surfaces of the vanes extend from the opposite longitudinal side edges.

9. The vertical-type two sided mirrored acrylic blind vanes window covering system of claim 1 wherein the front mirrored and rear mirrored planar surfaces of the vanes are oriented parallel to the associated vanes longitudinal axis.

10. The vertical-type two-sided mirrored acrylic blind vanes of claim 1 wherein the rear surfaces of mirrored acrylic sheet are joined, aligned and permanently bonded utilizing a spray mastic adhesive.

11. The vertical-type two-sided mirrored acrylic blind vanes window covering system of claim 1 wherein a plurality of front mirrored and rear mirrored acrylic elongated planar surfaces of the vanes are equal in width and length.

12. The vertical-type two-sided mirrored acrylic blind vanes window covering system of claim 1, wherein the vanes form one part mirrored acrylic.

13. The vertical-type two-sided mirrored acrylic blind vanes window covering system of claim 1 wherein the two relatively oppositely facing surfaces forming the two-sides are optical quality mirrored acrylic.

14. The vertical-type two-sided mirrored acrylic blind vanes window covering system of claim 1 wherein the bonded mirrored acrylic sheet thus forming one part is machine cut to the vanes dimensional width and length.

15. The vertical-type two sided mirrored acrylic blind vanes window covering system of claim 1 wherein the two-sided vanes is a rigid thickness of 0.120 mm.

16. The vertical-type two-sided mirrored acrylic blind vanes window covering system of claim 1 wherein the two-sided vanes rigid thickness combine functionality for use in the interior and the exterior environment.

17. The vertical-type two-sided mirrored acrylic blind vanes window covering system of claim 1 wherein a smooth finished polished invisible clear and rigid 0.120 mm thickness opposite longitudinal side edge extend from the top end to the bottom end of the said vane.

18. The vertical-type two-sided mirrored acrylic blind vanes window covering system of claim 1 wherein the said vanes can be jarred without shattering breakage and will withstand severe impacts without fracture.
